(19) United States
(12) Patent Application Publication
(10) Pub. No.: US 2005/0206474 A1
(43) Pub. Date: Sep. 22, 2005

(54) Network connecting wire structure

(76) Inventor: Chien-Pin Huang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/805,958

(22) Filed: Mar. 22, 2004

(51) Int. Cl. H01P 1/10

(52) U.S. Cl. 333/105

(57) ABSTRACT

A network connecting wire structure includes a network line, a first connecting plug mounted on a first end of the network line, a second connecting plug mounted on a second end of the network line, and a switch mounted between the first connecting plug and the second connecting plug. Thus, the switch can be used to change the connecting states between two connecting plugs, so that the network connecting wire structure is available for requirements of different functions.

### BACKGROUND OF THE INVENTION

1. Field of the Invention

The present invention relates to a network connecting wire structure, and more particularly to a network connecting wire structure having a switch that can be used to change the connecting states between two connecting plugs, so that the network connecting wire structure is available for requirements of different functions.

2. Description of the Related Art

A conventional network connecting wire can be used to connect two computers or connect multiple computers to the network. The conventional network connecting wire usually has two specifications, one of which is available for connection of the personal computer and a network connecting device, such as the hub, cable modem or the like so as to connect the personal computer to the LAN (local area network) or the internet, and the other has a cross-over structure and is available for connecting two personal computers.

However, the conventional network connecting wires having two different specifications cannot be commonly used with each other because of different connecting states of two connecting plugs at the two ends of the conventional network connecting wires. Thus, a user has to prepare two network connecting wires having two different specifications so as to connect the personal computer to the LAN (local area network) or the internet, and to connect two personal computers.

### SUMMARY OF THE INVENTION

The primary objective of the present invention is to provide a network connecting wire structure having a switch that can be used to change the connecting states between two connecting plugs, so that the network connecting wire structure is available for requirements of different functions.

Another objective of the present invention is to provide a network connecting wire structure that is available for connection of multiple personal computers and multiple network connecting devices, such as the hub, cable modem or the like and is also available for connecting two personal computers, thereby enhancing the versatility of the network connecting wire structure.

A further objective of the present invention is to provide a network connecting wire structure that is available for connection of multiple personal computers and multiple network connecting devices, and is also available for connecting two personal computers, thereby decreasing costs of fabrication of the network connecting wire structure.

In accordance with the present invention, there is provided a network connecting wire structure, comprising:
a network line;
a first connecting plug mounted on a first end of the network line;
a second connecting plug mounted on a second end of the network line; and
a switch mounted between the first connecting plug and the second connecting plug.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a network connecting wire structure in accordance with the preferred embodiment of the present invention;

FIG. 2 is a plan cross-sectional view of the network connecting wire structure as shown in FIG. 1; and

FIG. 3 is a perspective view of a network connecting wire structure in accordance with another embodiment of the present invention.

### DETAILED DESCRIPTION OF THE INVENTION

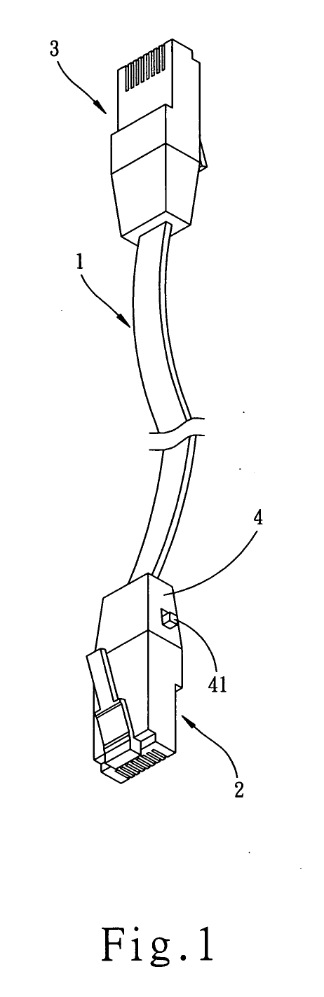

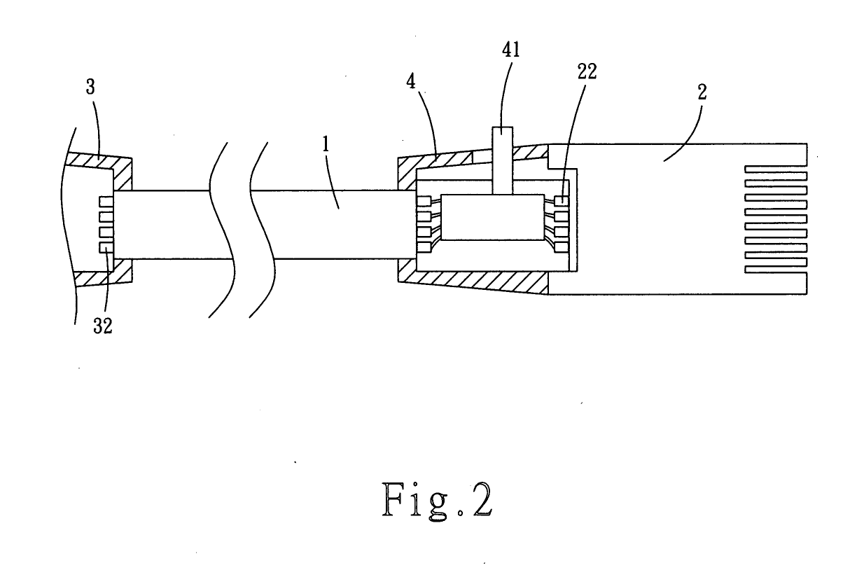

Referring to the drawings and initially to FIGS. 1 and 2, a network connecting wire structure in accordance with the preferred embodiment of the present invention comprises a network line 1, a first connecting plug 2 mounted on a first end of the network line 1, a second connecting plug 3 mounted on a second end of the network line 1, and a switch 4 mounted between the first connecting plug 2 and the second connecting plug 3.

The network line 1 is a signal line of a Ethernet having a specification of RJ45.

The first connecting plug 2 is a male connector having a specification of RJ45 for insertion into a female connector having a specification of RJ45. The first connecting plug 2 has an inside provided with a plurality of conducting terminals 22.

The second connecting plug 3 is a male connector having a specification of RJ45 for insertion into a female connector having a specification of RJ45. The second connecting plug 3 has an inside provided with a plurality of conducting terminals 32.

The switch 4 is provided with a push button 41 to switch the connecting states between the conducting terminals 22 of the first connecting plug 2 and the respective conducting terminals 32 of the second connecting plug 3. In the preferred embodiment, the switch 4 is integrally combined with the first connecting plug 2.

When in use, the first connecting plug 2 is inserted into a first female connector having a specification of RJ45, and the second connecting plug 3 is inserted into a second female connector having a specification of RJ45. At this time, the push button 41 of the switch 4 is movable between a first position and a second position.

When the push button 41 of the switch 4 is located at the first position, the conducting terminals 22 of the first connecting plug 2 and the respective conducting terminals 32 of the second connecting plug 3 are connected symmetrically, thereby forming a network line without producing cross-over, so that the network connecting wire structure is available for connection of multiple personal computers and multiple network connecting devices, such as the hub, cable modem or the like to connect the personal computers to the LAN (local area network) or the internet.

When the push button 41 of the switch 4 is located at the second position, the connecting states between the conducting terminals 22 of the first connecting plug 2 and the respective conducting terminals 32 of the second connecting plug 3 are changed, thereby forming a network line producing cross-over, so that the network connecting wire structure is available for connecting two personal computers.

Accordingly, the network connecting wire structure is available for connection of multiple personal computers and multiple network connecting devices, such as the hub, cable modem or the like, and is also available for connecting two personal computers, thereby enhancing the versatility of the network connecting wire structure. In addition, the network connecting wire structure is available for connection of multiple personal computers and multiple network connecting devices, and is also available for connecting two personal computers, thereby decreasing costs of fabrication of the network connecting wire structure.

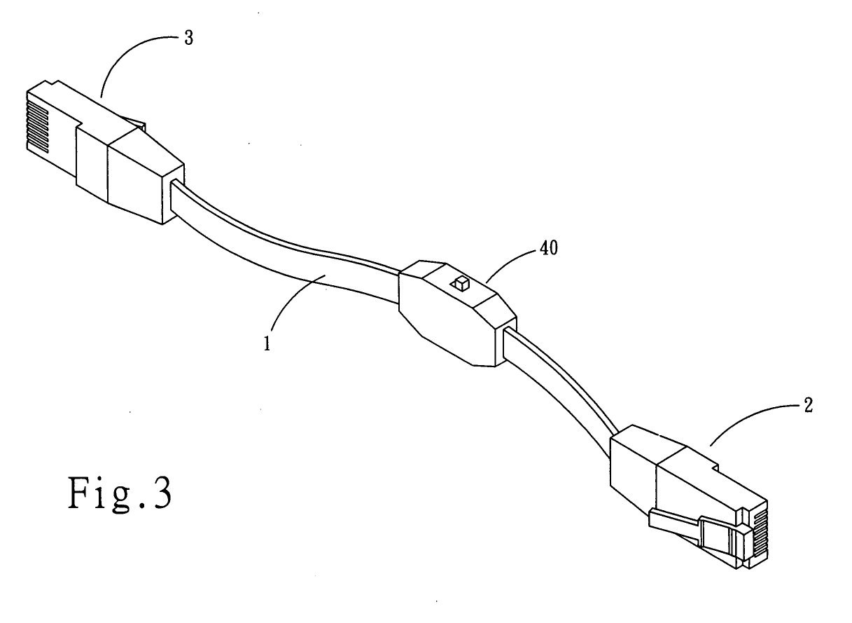

Referring to FIG. 3, in accordance with another embodiment of the present invention, the switch 40 is mounted on a mediate portion of the network line 1 and located between the first connecting plug 2 and the second connecting plug 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A network connecting wire structure, comprising:
a network line;
a first connecting plug mounted on a first end of the network line;
a second connecting plug mounted on a second end of the network line; and
a switch mounted between the first connecting plug and the second connecting plug.

2. The network connecting wire structure in accordance with claim 1, wherein the network line is a signal line of a Ethernet having a specification of RJ45.

3. The network connecting wire structure in accordance with claim 1, wherein the first connecting plug is a male connector having a specification of RJ45.

4. The network connecting wire structure in accordance with claim 1, wherein the second connecting plug is a male connector having a specification of RJ45.

5. The network connecting wire structure in accordance with claim 1, wherein the first connecting plug has an inside provided with a plurality of conducting terminals, the second connecting plug has an inside provided with a plurality of conducting terminals, and the switch is provided with a push button to switch a connecting state between the conducting terminals of the first connecting plug and the respective conducting terminals of the second connecting plug.

6. The network connecting wire structure in accordance with claim 5, wherein the push button of the switch is movable between a first position where the conducting terminals of the first connecting plug and the respective conducting terminals of the second connecting plug are connected, thereby forming a network line without producing cross-over, and a second position where the connecting state between the conducting terminals of the first connecting plug and the respective conducting terminals of the second connecting plug is changed, thereby forming a network line producing cross-over.

7. The network connecting wire structure in accordance with claim 1, wherein the switch is integrally combined with the first connecting plug.

8. The network connecting wire structure in accordance with claim 1, wherein the switch is mounted on a mediate portion of the network line and located between the first connecting plug and the second connecting plug.
